(19) United States
(12) Patent Application Publication
(10) Pub. No.: US 2008/0120846 A1
(43) Pub. Date: May 29, 2008

(54) Apparatus And Method For Manufacturing Outer Race Member For Constant Velocity Joint And Intermediate Molded Body Of The Outer Race Member

(75) Inventor: Yoshihisa Doi, Tochigi-ken (JP)

Correspondence Address: BIRCH STEWART KOLASCH & BIRCH, PO BOX 747, FALLS CHURCH, VA, 22040-0747, US

(73) Assignee: HONDA MOTOR CO., LTD., MINATO-KU, TOKYO (JP)

(21) Appl. No.: 11/666,615

(22) PCT Filed: Mar. 20, 2006
(86) PCT No.: PCT/JP2006/305612

§ 371 Date: Apr. 30, 2007

(30) Foreign Application Priority Data
Mar. 22, 2005 (JP) 2005-081166
Mar. 22, 2005 (JP) 2005-081430

(51) Int. Cl. B21K 1/04; F16D 3/26

(52) U.S. Cl. 29/898.066; 464/111

(57) ABSTRACT

An apparatus and a method for manufacturing an outer ring member for a constant velocity joint and an intermediate molded body. The apparatus includes a molding land formed in circular arc shape in cross section with a prescribed radius of curvature, a relief part continued with the molding land part, and a correcting land part continued with the relief part and larger than the outer diameter of the relief part formed at one end outer peripheral surface of a second punch for forming a hole in a shaft part drawn by a shaft part molding part. The entire part of the molding land part of the second punch is formed to be positioned between the upper end F1 and the lower end F2 of the shaft part molding part in the vertical direction of the through hole of a lower die.

### TECHNICAL FIELD

The present invention relates to an outer race member for a constant-velocity universal joint for transmitting rotational drive power, and more particularly, to an apparatus and method for manufacturing an outer race member for a constant-velocity universal joint, which has a plurality of guide grooves formed on an inner surface of a cup, and serrations formed on an inner surface of a shank through forging, as well as an intermediate formed (molded) body of such an outer race member for a constant-velocity universal joint.

### BACKGROUND ART

Heretofore, it has been customary to fill a cavity formed by an upper die and a lower die that are joined to each other with a forging material, and then to apply a pressing force to the forging material through a punch, for thereby producing an outer race member (outer cup) of a constant-velocity joint that is used for driving automotive wheels, for example.

The outer race member comprises a tubular cup and a shank integrally formed with the cup. The cup has three axially extending track grooves defined on an inner circumferential surface thereof at equal intervals in a circumferential direction, such that rollers can roll in and along the track grooves.

A conventionally used outer race member generally has a shank formed integrally with the cup, and which projects axially from an end of the cup (male type shank). On the other hand, a female type shank, having a hole formed therein with axially extending serrations on an inner circumferential surface thereof, has also recently been produced. The inner serrations of the shank engage with serrations of a rotational shaft of a differential mechanism.

When manufacturing such an outer race member for a constant-velocity universal joint, it is necessary to form a plurality of track grooves that extend axially along the inner circumferential surface of the cup in one step, and then to form serrations on the surface of the hole in the shank in another step.

In view of the above, the applicant has proposed a method for manufacturing such an outer race member for a constant-velocity universal joint, in which the track grooves and the serrations are formed more accurately and with improved concentricity, while making it possible to simultaneously form the track grooves in the cup and the serrations in the shank (see Patent Documents 1 through 3).

According to the conventional method proposed by the applicant for manufacturing an outer race member for a constant-velocity universal joint, first, a cylindrical billet 1 (see FIG. 12A) is upset to deform the billet 1a (see FIG. 12B) into a billet 1b that is partially expanded in diameter (see FIG. 12C). Then, the billet 1b is pressed by punches (not shown) from both sides in an axial direction to form a cup-shaped preliminary formed body 2 (see FIG. 12D). A large bore 4, with grooves similar to track grooves, is formed in the cup 3 of the preliminary formed body 2. On the other hand, a hole 6 without serrations is formed in the shank 5.

Subsequently, a burr 7 formed between the bore 4 of the cup 3 and the hole 6 in the shank 5 is punched out (see FIG. 12E) by a punch (not shown). Then, in a final step, the inner wall surface of the cup 3 is machined to complete the track grooves thereon, and the surface of the hole 6 in the shank 5 is machined to form serrations thereon, whereby the final product 9 is produced (see FIG. 12F).

Patent Document 4 discloses a cold-forging die for forming first outer splines and second outer splines extending in an axial direction on an outer circumferential surface of a rough bare metal body having a substantially tubular shape.

The cold-forging die for forming the splines includes an upper die, with a first spline forming land having forming portions and releasing portions thereon. The cold-forging die further includes a lower die, with a second spline forming land having forming portions, releasing portions, and correction portions thereon.

Patent Document 4 describes that, as a general matter, if the first and second spline forming lands both comprise forming portions and releasing portions, then when a pressing force is applied to the rough bare metal, the metal is bent in a direction perpendicular to the axial direction, such that axes of the first outer splines and the second outer splines deviate from each other.

Patent Document 4 further describes that, although first and second spline forming lands both have the forming portions, the releasing portions and the correcting portions may act to prevent deviation. With this structure, a reaction force generated in the second spline forming land is focused on the releasing portions, located between the forming portions and the correcting portions of the first spline forming land, thereby causing a large upset in the releasing portions of the first spline forming land. As a result, the splines formed on the side of the first spline forming land are totally misaligned.

In view of the above, Patent Document 4 discloses a cold-forging die for forming splines, comprising an upper die with a first spline forming land which has forming portions and releasing portions thereon, and a lower die with a second spline forming land which has forming portions, releasing portions, and correcting portions thereon. Patent Document 4 describes that, due to the correcting portions of the second spline forming land, the cold-forging die for forming splines prevents forces that bend the rough bare metal in a direction perpendicular to the axial direction from being applied to the rough bare metal. Therefore, it is possible to avoid deviation between the first outer splines and the second outer splines in the axial direction.

Further, Patent Document 4 describes that because there is no correcting portion on the first spline forming land, reaction forces generated in the second spline forming land are not focused on the releasing portions of the first spline forming land, thus causing less upset. As a result, the splines formed on the side of the first spline forming land are not misaligned.

However, the technical concept disclosed in Patent Document 4 concerns precisely forming the first outer splines and second outer splines on the outer circumferential surface and along the axial direction of the tubular rough bare metal. Therefore, the idea is remarkably different from the problem solved by the present invention, that is, to reduce loads applied to the die members in order to improve durability thereof.

Also, because the technical concept disclosed in Patent Document 4 relates to proposing an upper die, with the first spline forming land having forming portions and releasing portions thereon, and a lower die with the second spline forming land having forming portions, releasing portions and correcting portions thereon, it would not be possible for a person skilled in the art to apply such a concept to forming a hole in a female type shank of an outer race member.

According to the conventional method for manufacturing an outer race for a constant-velocity universal joint as proposed by the applicant, as shown in FIG. 12D, when the upper punch and the lower punch approach each other in the axial direction so as to simultaneously form the bore 4 of the cup 3 and the hole 6 in the shank 5, the hole 6 tends to be formed less accurately than the bore 4 of the cup 3, so that additional processing such as machining is required.

In addition, heavy loads are applied to the dies, thus shortening the useful lifespan of the dies.

Patent Document 1: Japanese Laid-Open Patent Publication No. 3-60838;

Patent Document 2: Japanese Laid-Open Patent Publication No. 3-60839;

Patent Document 3: Japanese Laid-Open Patent Publication No. 3-60840.

Patent Document 4: Japanese Laid-Open Patent Publication No. 8-215786.

### DISCLOSURE OF THE INVENTION

It is a general object of the present invention to provide a method for manufacturing an outer race member for a constant-velocity universal joint, including a hole with further improved dimensional accuracy in a shank thereof.

The main object of the present invention is to provide a method for manufacturing an outer race member for a constant-velocity universal joint, wherein a reduced load is applied to a die member for forming the hole, thereby improving durability of the die member.

Another object of the present invention is to provide a method for manufacturing an outer race member for a constant-velocity universal joint, wherein a dimensionally precise hole is formed in a shank, with a reduced load being applied to a die member for forming the hole, so as to improve durability of the die member with favorable material flows when forging the shank with the hole, as well as to provide an intermediate formed body for manufacturing the outer race member for the constant-velocity universal joint.

According to the present invention, a workpiece loaded in a cavity of an upper die is pressed vertically downward by a first die member. A shank-forming portion of a lower die draws a shank, while a second die member positioned coaxially with respect to the first die member presses the shank. Thus, a primary formed body, having a hole in the shank, is formed. Because the shank with the hole is extruded prior to upsetting the primary formed body in a subsequent step to obtain a secondary formed body, improved product accuracy is achieved when the completed product is produced in the subsequent step, while also reducing the amount of finishing work performed with respect to the hole in the subsequent step.

Further, according to the present invention, a forming land, a releasing portion, and a correcting land are formed on an outer circumferential surface at one end of the second die member, such that the forming land and the correcting land are not directly connected, owing to the releasing portion being formed therebetween. In addition, according to the present invention, because the forming land of the second die member is positioned inside of an area between one end (F1) and the other end (F2) of the shank-forming portion that is formed in the lower die in a vertical direction, a material flow toward the shank caused by drawing the lower side of the workpiece through the shank-forming portion of the lower die, and another upward material flow caused by pressing the lower central portion of the workpiece through the second die member, can be suitably regulated.

As a result, according to the present invention, material is prevented from sticking to the outer surface of the second die member that forms the hole in the shank. Also, the load applied to the second die member is reduced, so as to improve durability of the second die member. A hole having improved dimensional accuracy (formational accuracy) can be formed in the shank as well.

### BRIEF DESCRIPTION OF THE DRAWINGS

FIG. 1 is a flowchart of a process for manufacturing an outer race member for a constant-velocity universal joint according to a method of the present invention;

FIGS. 2A through 2F are side views and partial vertical cross-sectional views, each showing the shape of a workpiece forged in accordance with the manufacturing process of FIG. 1, to form the outer race member for a constant-velocity universal joint;

FIG. 3 is a vertical cross-sectional view schematically showing the structure of a first forging die used in a first cold-forging step according to an embodiment of the present invention, for forming a hole in a shank by forward extrusion;

FIG. 4 is a vertical cross-sectional view partially showing the material flows resulting when a hole is formed in the shank by a second punch;

FIG. 5 is a side view showing the second punch of the first forging die shown in FIG. 3;

FIG. 6 is a partially omitted enlarged side view of the second punch shown in FIG. 5;

FIG. 7 is a partially enlarged side view showing a positional relationship between a forming land that is formed in the second punch and a shank-forming portion that is formed in a lower die, in a state in which the entirety of the forming land is positioned inside of an area between an upper end F1 and a lower end F2 of the shank-forming portion;

FIG. 8 is a partially enlarged side view showing a state in which the entirety of the forming land is positioned inside of an area between the upper end F1 and the lower end F2 of the shank-forming portion;

FIG. 9 is a partially enlarged side view showing a state in which a portion of the forming land is positioned inside of an area between the upper end F1 and the lower end F2 of the shank-forming portion;

FIG. 10 is a partially enlarged side view showing a state in which the entirety of the forming land is positioned outside of an area between the upper end F1 and the lower end F2 of the shank-forming portion;

FIG. 11 is a partially enlarged side view showing a state in which the entirety of the forming land is positioned outside of an area between the upper end F1 and the lower end F2 of the shank-forming portion; and

FIGS. 12A through 12F are vertical cross-sectional views each showing a process of manufacturing an outer race member for a constant-velocity universal joint as previously proposed by the applicant.

### BEST MODE FOR CARRYING OUT THE INVENTION

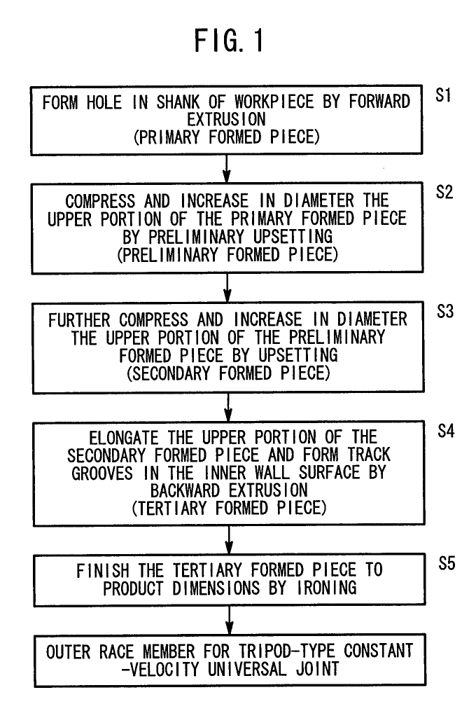

In a method for manufacturing an outer race member for a constant-velocity universal joint according to an embodiment of the present invention, as shown in the flowchart in FIG. 1, a workpiece 10 in the form of a cylinder (billet) of carbon steel is cold-forged multiple times so as to produce an outer race member for a tripod-type constant-velocity universal joint as a final product.

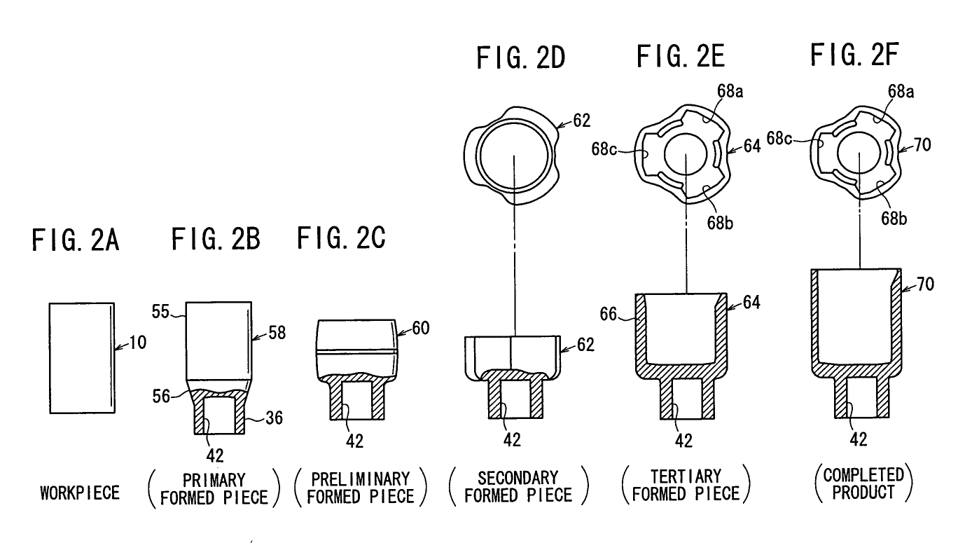

In a first preparatory step, the workpiece 10 (see FIG. 2A), which is cut into the form of a cylinder having a predetermined length, is treated by spheroidizing-annealing. As a result, the workpiece 10 is softened and can easily be treated in the first through fifth cold-forging steps to be described below.

In a second preparatory step, the workpiece 10 is coated with a lubricating chemical film. Specifically, a zinc phosphate lubricating chemical film is formed on the surface of the workpiece 10 by a bonderizing process in order to make the surface lubricative. Such a lubricating chemical film may be formed by immersing the workpiece 10 in a solvent containing zinc phosphate or the like dissolved therein for a predetermined period of time.

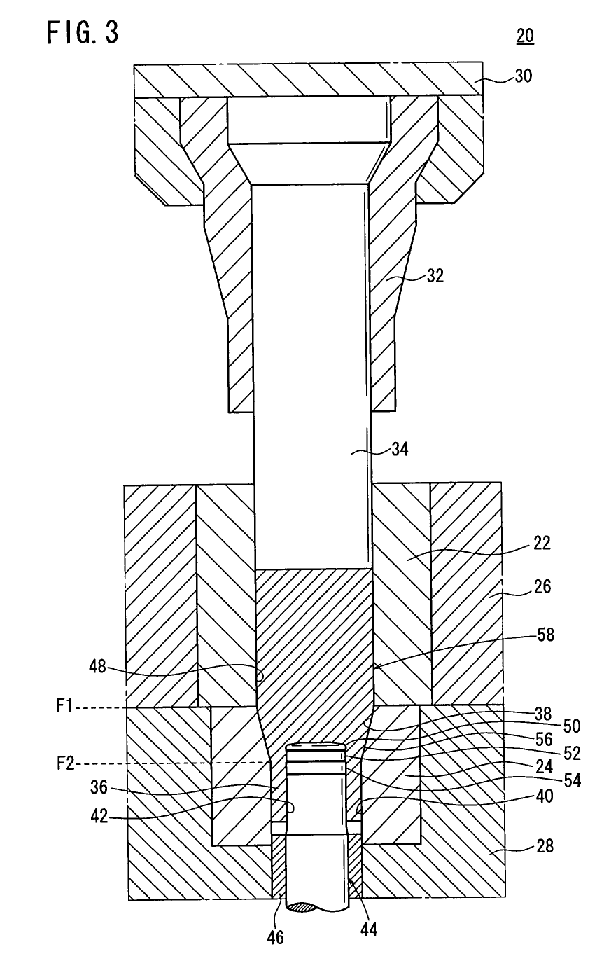

Then, in the first cold-forging step S1, one end face of the workpiece 10 coated with the lubricating chemical film is extruded in a forward direction to form a hole in a shank. The first forging die 20, which is used in the first cold-forging step S1 according to the embodiment of the present invention, is shown in FIG. 3.

The first forging die 20 includes an upper die 22 and a lower die 24. The upper die 22 and the lower die 24 are internally fitted respectively into a first die holder 26 and a second die holder 28, and thus are joined integrally to the first die holder 26 and the second die holder 28.

The first forging die 20 is fixed to a vertically movable member 30 that is coupled to a ram of a non-illustrated machine press through a punch holder 32. The first forging die 20 further includes a first punch 34, which presses the workpiece 10 vertically downwardly as the vertically movable member 30 descends, and a plurality of guide rods (not shown) which are fixedly installed in a die block (not shown) and which guide the vertically movable member 30 in the vertical direction. The first punch 34 functions as a first die member, which is vertically movable in accordance with operation of the non-illustrated machine press.

As shown in FIG. 3, the lower die 24 has a shank-forming portion 38 including a tapered hole having a diameter gradually reduced downwardly from a boundary between the upper die 22 and the lower die 24. A lower end of the shank-forming portion 38 is continuously connected to a through hole 40 having a constant inner diameter. Inside the through hole 40, a second punch 44 for forming a hole 42 in a shank 36 is disposed such that an end of the second punch 44 is directed upwardly. A cylindrical sleeve 46, which surrounds an outer surface of the second punch 44, is fitted onto an end of the second punch 44 and is held inside the through hole 40.

The second punch 44 functions as a second die member, and is vertically arranged coaxially with the first punch 34. The other end of the second punch 44 is fixed to another die holder (not shown). The second punch 44 is vertically movable in unison with the other die holder when a displacing means (not shown) abuts and presses a plurality of pins (not shown) fixed to the other die holder.

The upper die 22 comprises a cavity 48 formed by a through hole which is connected contiguously to an upper end of the shank-forming portion 38 formed in the lower die 24, and has an inner diameter identical to that of the shank-forming portion 38. The workpiece 10 is loaded into the cavity 48.

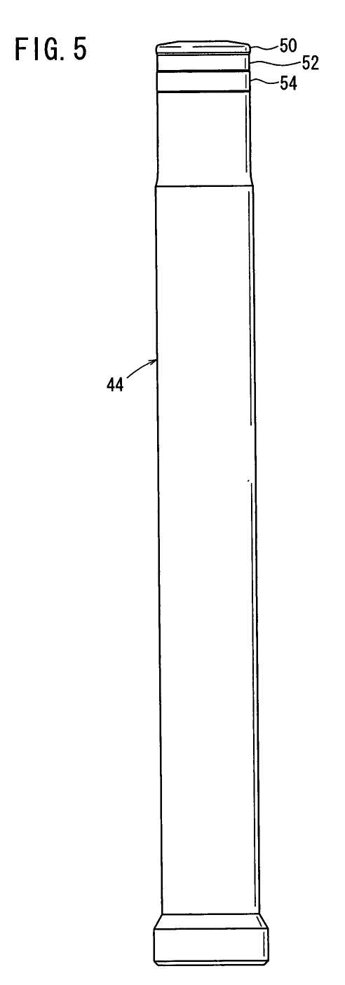

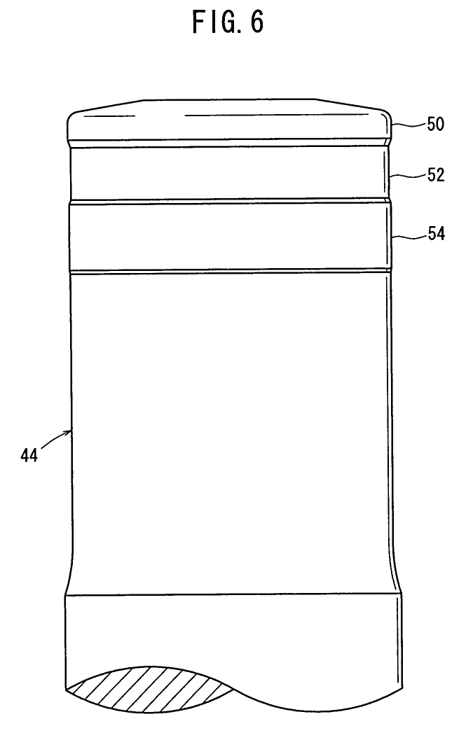

As shown in FIGS. 5 and 6, the outer circumferential surface at one end of the second punch 44, which faces upwardly in the through hole 40, comprises a forming land 50 having an arc-shaped cross section with a predetermined curvature on its tip end, a releasing portion 52 having a constant width and which is contiguous with the forming land 50 in the axial direction, and further which has a constant outer diameter that is smaller than an outer diameter at a maximal portion of the forming land 50, and a correcting land 54 contiguous with the releasing portion 52 in the axial direction, and which is in the form of an annular projection having an outer diameter greater than that of the releasing portion 52.

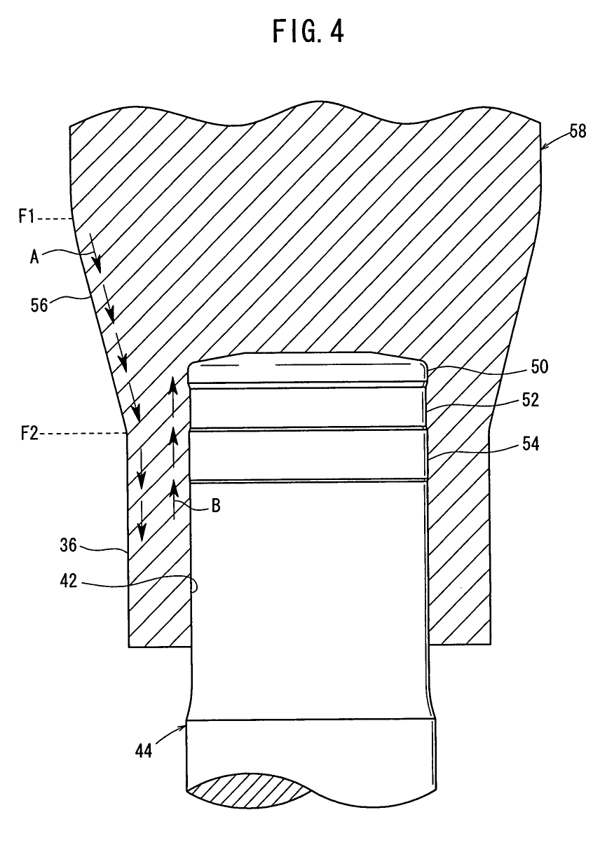

The entirety of the forming land 50, including the tip end face of the second punch 44, is vertically positioned in the through hole 40 of the lower die 24, inside of an area between an upper end (one end) F1 as a starting point and a lower end (other end) F2 as an end point of the shank-forming portion 38 that is formed in the lower die 24 (see FIGS. 3 and 4).

In this case, the releasing portion 52 is formed between the forming land 50 of the tip end face and the correcting land 54, and the forming land 50 is not directly connected to the correcting land 54, thus making it possible to reduce frictional resistance when forming a hole in the shank 36 by the second punch 44, while also reducing loads applied to the second punch 44.

The first forging die 20 according to the present embodiment is formed basically as described above. Primary cold-forging of a workpiece (billet) 10 introduced into the cavity 48 of the upper die 22 of the first forging die 20, i.e., forward extrusion for forming a hole in the workpiece 10, is carried out as outlined below.

First, the machine press is driven in order to lower the vertically movable member 30 that is connected to the ram of the machine press. While the vertically movable member 30 is lowered, the first punch 34 descends and finally abuts against the upper surface of the workpiece 10.

When the first punch 34 further descends so as to press the upper surface of the workpiece 10, a lower side of the workpiece, i.e., the side thereof that is opposite to the pressed upper surface of the workpiece 10, is drawn by the shank-forming portion 38. As a result, as shown in FIG. 2B, a primary formed piece (primary formed body) 58 having the hole 42 therein is obtained. The hole 42 is formed in the shank 36 by one end of the second punch 44, which is supported by a die holder (not shown) and inserted into the through hole 40 of the lower die 24. The formed primary formed piece 58 consists of a cylinder 55 having a shape corresponding to the outer shape of the workpiece 10, a tapered reduced-diameter portion 56 contiguously formed below the cylinder 55, and the shank 36 which is contiguous with the reduced-diameter portion 56.

This primary formed piece 58 functions as an intermediate formed body. The hole 42 in the primary formed piece 58 has a flat bottom positioned between the boundary defined by the cylinder 55 and the reduced-diameter portion 56, and the boundary defined by the reduced-diameter portion 56 and the shank 36 (see FIGS. 3 and 4).

In this case, because the forming land 50 and the correcting land 54 formed in one end of the second punch 44 are not directly connected with each other, but rather the releasing portion 52 is interposed therebetween, frictional resistance when forming the hole in the shank 36 is reduced, so that loads applied to the second punch 44 are reduced.

In addition, because the forming land 50, which makes up the tip end face of the second punch 44 in the vertical direction, is positioned inside of an area between an upper end (one end) F1 as a starting point and a lower end (other end) F2 as an end point of the shank-forming portion 38 formed in the lower die 24, favorable material flows are developed, including one material flow toward the shank caused by drawing the lower side of the workpiece 10 through the tapered shank-forming portion 38 of the lower die 24 (see arrow A in FIG. 4), and another upwardly directed material flow caused by pressing the lower central portion of the workpiece 10 through the second punch 44 (see arrow B in FIG. 4).

In other words, due to formation of suitable material flows, including the material flow in the outer region near the reduced-diameter portion 56 and the opposite material flow in the inner region near the hole 42, material is prevented from becoming stuck to the outer surface of the second punch 44, whereby loads applied to the second punch 44 are reduced, thus making it possible to improve durability of the second punch 44, while also improving dimensional accuracy of the hole 42 that is formed in the shank 36.

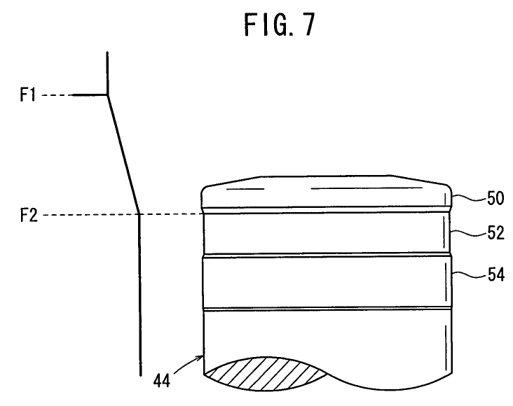

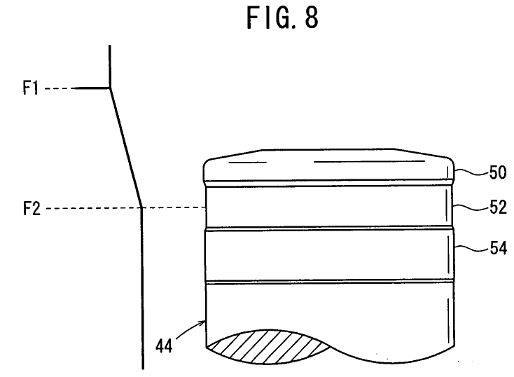

With respect to the relative positioning of the shank-forming portion 38 of the lower die 24 and the second punch 44, as shown in FIGS. 7 and 8, the entirety of the forming land 50 of the second punch 44 is positioned inside of an area defined between the upper end F1 as a starting point and a lower end F2 as an end point of the shank-forming portion 38.

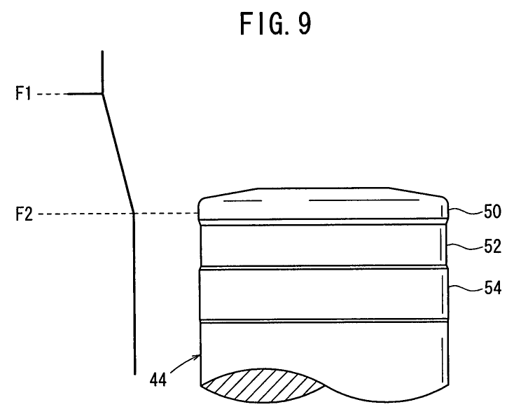

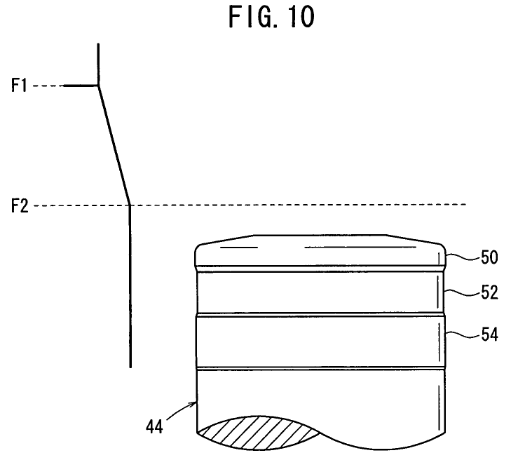

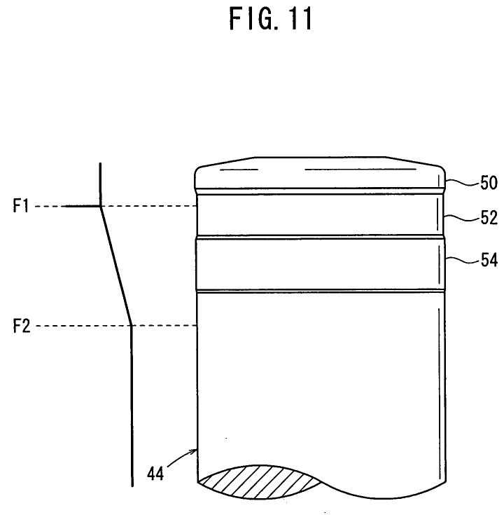

On the other hand, as shown in FIGS. 9 through 11, in the event that only a portion of the forming land 50 is positioned inside of the area between the upper end F1 and the lower end F2, or if the entirety of the forming land is positioned outside of this area, the material flows in the outer region and the inner region of the reduced-diameter portion 56 cannot be easily and suitably created.

Thereafter, the machine press is driven in order to lift the first punch 34 upwardly together with the ram and the vertically movable member 30. Then, a displacing means (not shown) is raised in order to push up the primary formed piece 58, as shown in FIG. 2B.

As described above, according to the present embodiment, because the shank 36 having the hole 42 therein is extruded prior to upsetting in the secondary cold-forging step S3, the completed product as finally obtained is improved in product accuracy, while also reducing the amount of finishing work required to be performed on the hole 42 in a subsequent step. The hole 42 in the shank 36 is formed with substantially the same shape as the hole 42 of the completed product 70, i.e., the aforementioned outer race member for a constant-velocity universal joint.

Next, preliminary upsetting is performed on the primary formed piece 58 (S2). More specifically, the primary formed piece 58 is loaded into a cavity of a second forging die (not shown). During preliminary upsetting, the shank 36 also is inserted into a shank holder (not shown) of the second forging die.

An upper portion of the primary formed piece 58 is pressed by a punch in order to flatten the primary formed piece 58, while a pressing and stopping member (not shown) supports a tip end of the shank 36 that is inserted into the shank holder (not shown). The primary formed piece 58 is thus flattened such that the upper portion thereof is compressed and expanded in diameter, thereby forming a preliminary formed piece 60 (see FIG. 2C). The preliminary upsetting step (S2) can possibly be dispensed with, depending on the degree to which the forging stock has been formed, the material properties of the forging stock, and the like.

Subsequently, in a secondary cold-forging step S3, upsetting is conducted further on the upper portion of the preliminary formed piece 60, so as to compress the upper portion and expand it in diameter, thereby forming a secondary formed piece 62 (see FIG. 2D).

When the upper portion of the preliminary formed piece 60 loaded into the cavity of the second forging die (not shown) is pressed by the punch (not shown), the upper portion of the preliminary formed piece 60 is deformed in an axial direction by compression, so as to obtain the secondary formed piece 62.

Following completion of the secondary cold-forging step S3, the secondary formed piece 62 is annealed at a low temperature to remove stresses therefrom. Further, the annealed secondary formed piece 62 is treated by shot blasting to remove oxide scales, etc., produced as a result of low-temperature annealing, and a bonderizing process is conducted so that a lubricating chemical film of zinc phosphate or the like is formed on the outer surface of the secondary formed piece 62. By performing such processes on the secondary formed piece 62, the secondary formed piece 62 can be plastically deformed with ease.

Thereafter, a tertiary cold-forging step S4 is performed using a third forging die (not shown). The tertiary cold-forging step is carried out with respect to the secondary formed piece 62, having a shank inserted into a shank insertion portion of the third forging die (not shown), so as to obtain the tertiary formed piece 64 (see FIG. 2E).

Following completion of the tertiary cold-forging step S4, a quaternary cold-forging step S5 is performed on the tertiary formed piece 64. Before the quaternary cold-forging step S5 is performed, either the surface of the tertiary formed piece 64 or the surface of a fourth forging die (not shown) may be coated with a liquid lubricant to prevent seizure from occurring on the tertiary formed piece 64 or on the fourth forging die while the quaternary cold-forging step S5 is being performed. The liquid lubricant may be a known liquid lubricant that has heretofore been used.

In the quaternary cold-forging step S5, the non-illustrated fourth forging die is used to effect ironing (final sizing) on inner and outer surfaces of the tertiary formed piece 64, in order to finish the cup 66 into a final product shape. Specifically, the tertiary formed piece 64 is machined such that the wall thickness of the cup 66, as well as the width and depth of the track grooves 68a through 68c, acquire a given dimensional accuracy, thereby producing the outer race member for a tripod-type constant-velocity joint as a completed product 70 (see FIG. 2F), wherein the cup 66 has the required dimensional accuracy, including the shape of the track grooves 68a through 68c, etc.

According to the present embodiment, prior to carrying out upsetting by the secondary cold-forging step S3, the hole 42 is formed in the shank 36 using the second punch 44 in step S1, so as to improve the dimensional accuracy of the hole 42 formed in the shank 36. In addition, owing to the suitable material flows that occur during forming of the shank 36 by forging, loads applied to the second punch 44 that serves as the second die member are reduced, resulting in improved durability of the second punch 44.

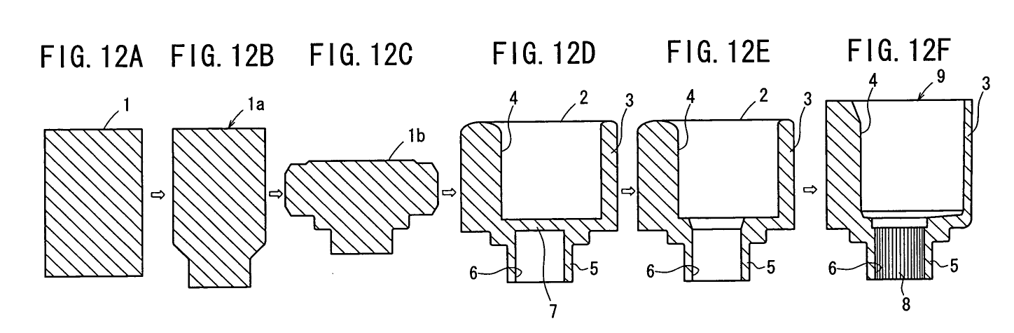

Stated otherwise, as shown in FIG. 12D, in the method for manufacturing an outer race member for a constant-velocity universal joint as previously proposed by the applicant, because the bore 4 of the cup 3 and the hole 6 in the shank 5 are simultaneously formed by the upper punch and the lower punch, accuracy of the hole 6 is inferior and heavy loads may undesirably be applied to the die. In contrast, according to the embodiment of the present invention, because the hole is formed in the shank 36 during the first forging step performed on the cylindrical workpiece 10, and the bore of the cup 66 is formed separately and independently in a subsequent step, the hole 42 formed in the shank 36 has improved dimensional accuracy. In addition, as a result of suitable material flows that occur when forming the shank 36 by forging, loads applied to the second punch 44 for forming the hole 42 are reduced, thereby improving the durability of the second punch 44.

1. An apparatus for manufacturing an outer race member for a tripod-type constant-velocity universal joint including a shank having a hole and a cup, which are formed integrally with each other by cold-forging, wherein a cylindrical workpiece cut to a predetermined length is extruded into a primary formed body made up of a shank with the hole therein prior to being upset, said apparatus comprising:
an upper die including a cavity into which the workpiece is loaded;
a lower die assembled integrally with said upper die, said lower die comprising a shank-forming portion including a tapered hole having a diameter gradually reduced downwardly;
a vertically movable first die member for vertically downwardly pressing on said workpiece that is loaded in said cavity; and
a second die member having a substantially cylindrical shape including one end inserted into a through hole contiguous to said shank-forming portion, said second die member forming a hole in said shank drawn by said shank-forming portion,
wherein an outer circumferential surface at one end of said second die member comprises a forming land having an arc-shaped cross section of a predetermined curvature, a releasing portion (contiguous with said forming land along an axial direction of said second die member, and a correcting land contiguous with said releasing portion in said axial direction, said correcting land having an outer diameter greater than that of the releasing portion, and
wherein an entirety of said forming land of said second die member is positioned inside of an area between one end and another end of said shank-forming portion, in a vertical direction along said through hole of said lower die.

2. The apparatus for manufacturing an outer race member for a constant-velocity universal joint according to claim 1, wherein said forming land and said correcting land are disposed discontinuously from each other.

3. The apparatus for manufacturing an outer race member for a constant-velocity universal joint according to claim 1, wherein said releasing portion has an outer diameter that is smaller than a maximum diameter of said forming land.

4. A method for manufacturing an outer race member for a tripod-type constant-velocity joint including a shank having a hole and a cup, which are formed integrally with each other by cold-forging, comprising the steps of:
extruding a cylindrical workpiece cut to a predetermined length so as to form a primary formed body having a shank with the hole therein;
upsetting a portion of said primary formed body, except for said shank thereof, thereby deforming said portion by compression in an axial direction thereof to form a secondary formed body;
extruding said secondary formed body backward to form a tertiary formed body having a cup with track grooves defined therein; and
ironing said cup of said tertiary formed body.

5. The method for manufacturing an outer race member for a constant-velocity universal joint according to claim 4, wherein said hole in said shank is formed when a first punch vertically presses said workpiece, and while a second punch positioned coaxially with said first punch presses said shank drawn by a shank-forming portion of a die.

6. The method for manufacturing an outer race member for a constant-velocity universal joint according to claim 5, wherein a tip end of said second punch is positioned inside of an area between one end and another end of said shank-forming portion.

7. An intermediate formed body of an outer race member for a tripod-type constant-velocity universal joint including a shank having a hole and a cup, which are formed integrally with each other by cold-forging, the intermediate formed body comprising:
a primary formed body having a shank with the hole formed therein by extruding a cylindrical workpiece which has been cut to a predetermined length,
wherein said primary formed body comprises a cylinder having a shape corresponding to a shape of said workpiece, a tapered reduced-diameter portion formed in an axial direction contiguously with the cylinder, and the shank which is contiguous with said tapered reduced-diameter portion and comprises said hole formed by said extruding.

8. The intermediate formed body according to claim 7, wherein said hole has a flat bottom positioned between a boundary of said cylinder and said reduced-diameter portion, and a boundary of said reduced-diameter portion and said shank.
